(19) United States
(12) Patent Application Publication
(10) Pub. No.: US 2009/0151148 A1
(43) Pub. Date: Jun. 18, 2009

(54) PROCESSING APPARATUS

(76) Inventors: Hubert REINISCH, Freiberg/Neckar (DE); Thomas Weiler, Ingersheim (DE)

Correspondence Address: HARNESS, DICKEY & PIERCE, P.L.C., P.O. BOX 828, BLOOMFIELD HILLS, MI, 48303, US

(21) Appl. No.: 12/339,633

(22) Filed: Dec. 19, 2008

Related U.S. Application Data
(63) Continuation of application No. PCT/EP2007/005879, filed on Jul. 3, 2007.

(30) Foreign Application Priority Data
Jul. 4, 2006 (DE) 10 2006 032 121.9

(51) Int. Cl. B23Q 39/00; B23Q 41/02; B23P 21/00

(52) U.S. Cl. 29/564.1; 29/563

(57) ABSTRACT

The invention relates to a processing apparatus, a “process bench”, for processing a workpiece transported on a work carrier, having a base module and at least one process module which can be inserted into the base module at a point within an accommodating region. Each process module processes, assembles or tests workpieces, for example also pharmaceutical and medico-technical products. The processing apparatus is characterized in that the base module comprises a support device which is designed to accommodate process modules or functional modules at any desired point or at a multiplicity of predetermined points within the accommodating region.

### CROSS REFERENCES TO RELATED APPLICATIONS

This application is a continuation of copending international patent application PCT/EP2007/005879 filed on Jul. 3, 2007 and designating the U.S., which was published in German and claims priority of German patent application DE 10 2006 032 121.9 filed on Jul. 4, 2006. The entire contents of these applications are incorporated herein by reference.

### BACKGROUND OF THE INVENTION

The present invention relates to a processing apparatus, a “process bench”, for processing a workpiece transported on a work carrier, having a base module and at least one process module which can be inserted into the base module at a point within an accommodating region.

Processing apparatuses or processing stations of the aforesaid type are generally known. Thus the applicant markets, for example, such processing apparatuses under the name “TEAMOS”. In addition, such a processing apparatus is also known from document DE 197 41 671 A1. Document EP 1 637 280 A1 also shows a processing apparatus which is composed of a base module and process modules.

In general, a processing apparatus is normally a modular processing, assembly and/or test system which serves to process, assemble and/or test products, for example also pharmaceutical and medico-technical products. Within the processing system, each processing station has at least one specific function which is to be carried out on the product. For example, a function may consist in connecting two housing parts to one another, in carrying out a leakage test, in carrying out an electrical functional test, in carrying out soldering, etc. Another function consists in inscribing a housing part by laser. In the case of pharmaceutical and medico-technical products, processes such as, for example, metering of liquids and substances, metering of medicines, heat treatment of substances, radiation substances, metering of medicines, heat treatment of substances, radiation processes, processing of monomers or polymers, etc., are of importance.

These functions are carried out automatically in the processing stations. In addition, a processing system also comprises, for example, manual processing stations, where the functions are carried out manually, and pure transfer stations which merely serve for the onward transport of the work carriers equipped with the products.

Shown in the abovementioned document are processing stations which comprise a plurality of “process modules”. These process modules are each self-contained independent apparatuses which perform a specific function. Since a processing station can accommodate a plurality of such process modules, it is therefore possible to perform a plurality of functions in one processing station.

Provided for accommodating the process modules is a “base module” which has push-in unit receptacles for the individual process modules. The base modules normally have four push-in unit receptacles with in each case a width of 400 mm, into which process modules with a matrix of corresponding width (400 mm, 800 mm, etc) can be inserted.

In addition to these push-in unit receptacles, the base module comprises a switch cabinet which is fixedly installed in the base module and which accommodates, inter alia, the central control devices necessary for the control of the process modules. In connection with the present application, the expression “base module” in principle refers to an apparatus which comprises at least one frame for accommodating independent process modules and components which are not specific to the process modules, such as, for example, energy supply, switching devices, etc.

If a processing system is to be extended, a further processing station consisting of a base module and a plurality of process modules is fitted in.

In principle, therefore, processing systems consist of one or more processing stations which each have a base module of identical construction and process modules adapted to the respective functions to be performed.

Although these modular processing stations have been extremely successful on the market, there is still the desire to increase the flexibility of such processing stations and to reduce the production costs.

### SUMMARY OF THE INVENTION

Against this background, the object of the present invention is to develop the processing apparatus mentioned at the beginning in such a way that it offers greater flexibility during set-up, changeover, etc., and in addition can be offered at a lower cost.

This object is achieved by the processing apparatus mentioned at the beginning in that the base module comprises a support device which is designed to accommodate process modules or functional modules at any desired point or at a multiplicity of predetermined points within the accommodating region.

That is to say that the processing apparatus according to the invention does not have—as in previous solutions—a plurality of fixed push-in unit receptacles, the width of which corresponds in each case to the minimum “matrix” width of a process module. On the contrary, the support device of the processing apparatus according to the invention offers the possibility of arranging the process modules and/or functional modules within the accommodating region at any desired point or at a multiplicity of predetermined points. If a process module in the known processing station having four push-in unit receptacles could be accommodated at four points within the accommodating region, the process module in the processing apparatus according to the invention can be accommodated at a markedly greater number of points. Furthermore, functional modules can now also be accommodated freely or virtually freely within the accommodating region, functional modules being self-contained subassemblies which perform no workpiece-processing function, such as transport, control unit, which is assigned to a specific number of process modules, media and energy supply, housing, etc.

The number of predetermined points is preferably greater than the maximum number of process modules that can be inserted, the process module of smallest width being taken as a basis in this case.

On the whole, an increase in flexibility in the configuration of a processing apparatus can thus be achieved. Further standardization of components can be effected due to the greater flexibility, such that the production costs can be reduced overall.

Compared with the solution shown in the abovementioned document EP 1 637 280 A1, the present invention therefore has the advantage that firstly the process modules can be arranged within the processing apparatus in a markedly more flexible manner. Secondly, functional modules, that is to say, for example, housing parts, switch cabinets, etc., can also be arranged within the processing apparatus in a markedly more flexible manner.

In a preferred embodiment, the support device is formed from at least one support element with a rear support and a bottom bearing surface which in each case extend over the entire length of the support element. The support device preferably provides an accommodating region which extends over the entire length of the support device.

These measures have the advantage that a maximum region is available for accommodating process modules. In addition, it is thereby possible to couple support elements to one another, as a result of which an even greater uninterrupted accommodating region is obtained.

In a preferred embodiment, parts for constructing a housing are designed as functional modules which can be inserted into the accommodating region. Central control devices or switch cabinets assigned to the processing apparatus are designed as functional modules which can be inserted into the accommodating region. Furthermore, parts of the conveying device provided for transporting the work carriers are also preferably designed as a functional module which can be inserted into the accommodating region.

In other words, virtually all the subassemblies of a processing apparatus are of modular construction, irrespective of whether they perform general functions or workpiece-processing functions, and consequently can be inserted into the accommodating region of the support device in a very flexible manner. Thus, for example, the central control device, which in previous processing stations, such as, for example, the abovementioned EP 1 637 280 A1, was a fixed component of the base module, is provided as an independent modular unit which can be inserted within the accommodating region at any or at virtually any desired point. The ultimate consequence of this construction is that processing stations in the conventional sense which are characterized by a frame having a fixedly attached control device and a specific number of push-in unit receptacles for process modules no longer exist. Thus the flexibility during planning and during the construction of a processing system can be further increased.

In a preferred embodiment, the support device is composed of at least two support elements.

That is to say that the support device does not constitute a one-piece device but rather can be composed, for example, of a plurality of support elements. The support elements have an analogous construction and can vary in their length. As a result, the flexibility can be further increased and the possibility of further extension improved.

In a preferred embodiment, the support has a fastening rail which extends over the entire length of the accommodating region and which interacts in a retaining and indexing manner with a retaining element attached to a process plate of the process module. The fastening rail preferably has a hole matrix for accommodating indexing and fastening pins.

That is to say that the support has a means which allows pins to be attached at fixed distances apart. The process plate of the process module to be inserted can be set down on these pins, the pins then engaging in corresponding drill bushes in the process plate. As a result, the position of the process module is indexed, that is to say fixed. Screws can then be screwed through these pins into the support in order to firmly connect the process plate to the support element.

The hole matrix size is preferably selected in such a way that the minimum width of a process module is a multiple (also including the factor of 1) of this hole matrix size. If, for example, 400 mm is selected as the minimum process module width, a preferred hole matrix size can be 100 mm, that is to say, for example, one quarter of the process module matrix. Process modules can consequently be inserted at points or positions within the accommodating region which are each separated by this distance of 100 mm.

At this point, however, it may be noted that other technical solutions for indexing and fastening process modules on the support device are also conceivable. In addition, it is also conceivable to design the support in such a way that the process modules can be fastened at any desired points. In this case, the “matrix arrangement” would be dispensed with.

Finally, it may also be noted at this point that the functional modules may also be inserted like the process modules into the accommodating region of the support device. The functional modules can consequently likewise be inserted at any or at virtually any desired points (when using a hole matrix) within the accommodating region of the process bench. In this case, all the modules which do not carry out direct processing on the workpiece are designated as functional modules.

In a preferred embodiment, the bearing surface of the support device has at least one hole matrix rail extending over the length of the accommodating region, wherein the hole matrix can correspond to that of the fastening rail, but is not absolutely necessary. For example, the hole matrix of the fastening rail of the top member can be 100 mm and that of the bottom supporting surface can be 50 mm.

This hole matrix rail is used to connect the process modules or the functional modules to the process bench at a further point.

The object of the invention is also achieved by a process module for such a processing apparatus according to the invention, said process module having a process plate and a switch cabinet and being characterized in that at least one retaining element is provided on the process plate, said retaining element being adapted to the fastening rail of the support of the process bench in order to interact with said fastening rail in a retaining and indexing manner.

The advantages of this measure have already been explained above, and therefore they need not be dealt with again.

Further advantages and configurations of the invention follow from the description and the attached drawing.

It goes without saying that the abovementioned features and the features still to be explained below can be used not only in the respectively specified combination but rather also in other combinations or on their own without departing from the scope of the present invention.

### BRIEF DESCRIPTION OF THE DRAWINGS

The invention will now be explained in more detail with reference to exemplary embodiments and the drawing, all the process modules being depicted without the actual process construction for the sake of clarity. In the drawing:

FIG. 1 shows a perspective view of a processing apparatus according to a first embodiment;

FIG. 2 shows a perspective illustration of a partly constructed processing apparatus;

FIG. 3 shows a perspective illustration of the process bench shown in FIG. 2, with further added components;

FIG. 4 shows a perspective illustration of a support device according to a further embodiment;

FIG. 5 shows a detailed illustration of the support device shown in FIG. 4;

FIG. 6 shows a perspective illustration of the support device with some inserted process modules and a functional module;

FIG. 7 shows a perspective illustration of a finish-constructed process bench where the process bench is extended in the direction of view; and

FIG. 8 shows a schematic block diagram of the basic construction of a processing system.

### DETAILED DESCRIPTION OF PREFERRED EMBODIMENTS

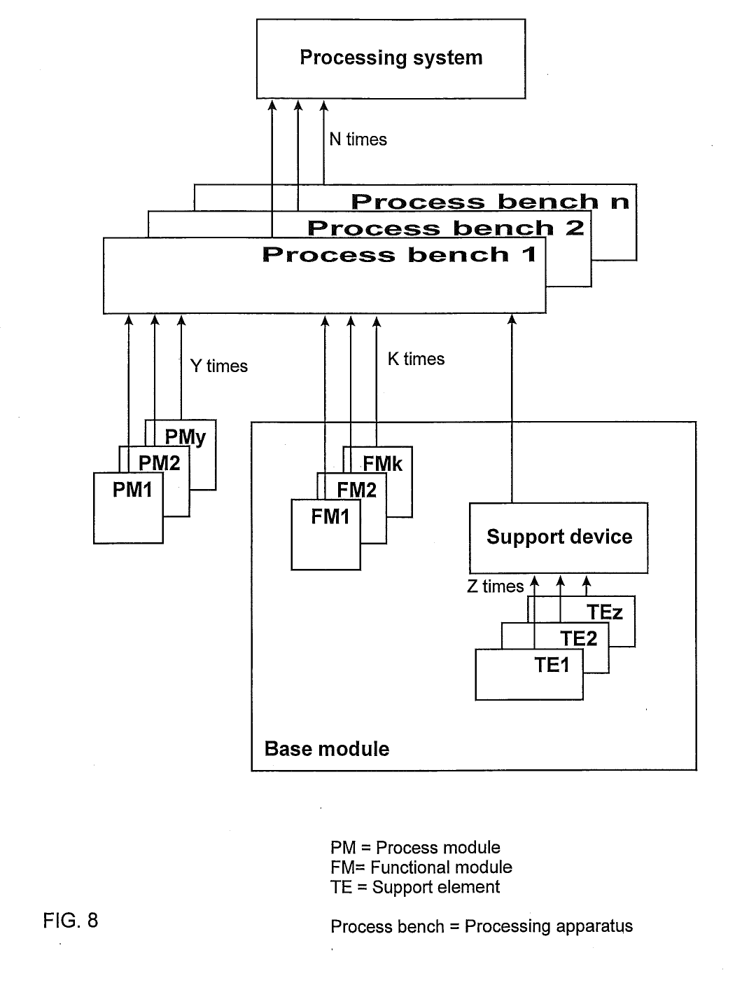

The basic construction of a processing system is shown schematically in FIG. 8. A processing system generally consists of one or more processing apparatuses which are designated as process benches.

A processing apparatus, i.e. a process bench, is composed of a base module and at least one process module.

The base module, in contrast to the previous solutions, is in turn likewise of modular construction and comprises a support device having an accommodating region for accommodating process modules and “functional modules”. Both process modules and functional modules can be inserted into the accommodating region of the support device at any or at virtually any desired point. The expression “can be inserted” means firstly that the requisite space for the module is available and secondly that fastening of the module to the support device is possible. Consequently, “insertion” in the sense of the invention is the placing of the module in the desired position and the fastening or connecting of the module to the support device.

“Functional modules” refer to all those apparatuses which carry out no direct processing on the workpiece, that is to say a transport apparatus, a control device accommodated in a switch cabinet, or housing parts, to mention only a few examples. In principle, a functional module is any module which can be inserted into the support device and which does not carry out processing on a workpiece.

Finally, the support device is formed from one or more support elements of the same or different length which are coupled to one another, the support elements forming the continuous accommodating region, such that process or functional modules can also be inserted over a support element, i.e. are carried by two adjacent support elements.

Proceeding from this abstract construction of a processing system, exemplary embodiments of a process bench are shown and explained below. However, it should be noted that this concerns embodiments that are representative of further conceivable embodiments (not shown) and are not intended to restrict the invention thereto.

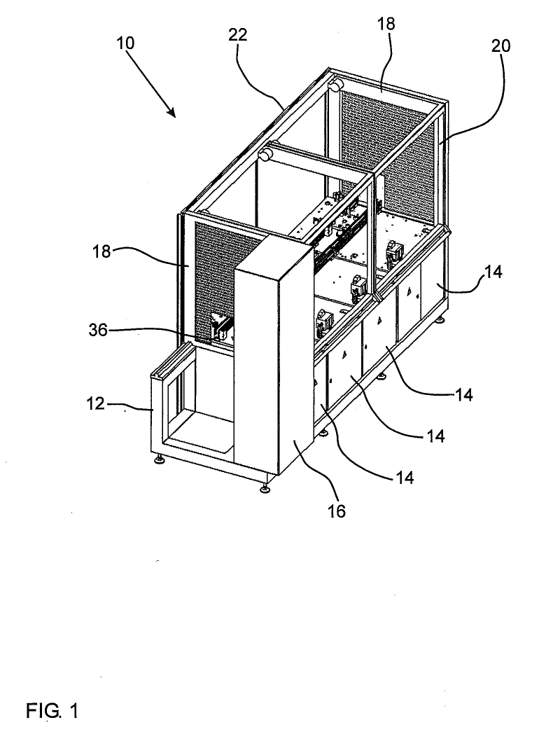

A process bench with functional modules and the support device will now be described in detail with reference to FIGS. 1 to 7.

A process bench is shown in perspective in FIG. 1 and is identified by the reference numeral 10. The process bench 10 may be part of a larger processing system which is composed of a multiplicity of such process benches 10 or of similar process benches 10. However, the process bench 10 shown may also be operated individually, e.g. with a manually synchronized work carrier or in combination with a transport system.

In principle, the process bench 10 serves to process, assemble and/or test a workpiece, transported on a work carrier, when passing through the process bench. The processing may consist, for example, in fitting a cell phone housing with the electronic subassemblies, in inscribing the housing by laser, or the like. The applicant in the meantime offers a multiplicity of different processes for the “TEAMOS” processing system already mentioned.

The individual processes within the process bench 10 are carried out by “process modules”, which are identified by the reference numeral 14 in FIG. 1. For different processes, different process modules 14 adapted thereto can be provided in the process bench 10. In the process bench shown, a total of four process modules are provided by way of example.

The process modules 14 are inserted into a support frame, which is identified by the reference numeral 12 in FIG. 1 and is referred to below as support device. The construction of this support device 12 will be explained in more detail below.

In addition to the process modules 14, the process bench 10 has a switch cabinet 16 which accommodates the subassemblies required for the central control and supply of the process modules. This includes in particular electronic control groups.

Finally, the process bench 10 has a housing which consists of two side walls 18, a rear wall 22 and a door 20 and which encloses a process space in which the individual processing steps are carried out on the workpiece passing through this process space. Also shown schematically in FIG. 1 is a conveyor device 36 which provides for the transport of the work carriers equipped with at least one respective workpiece.

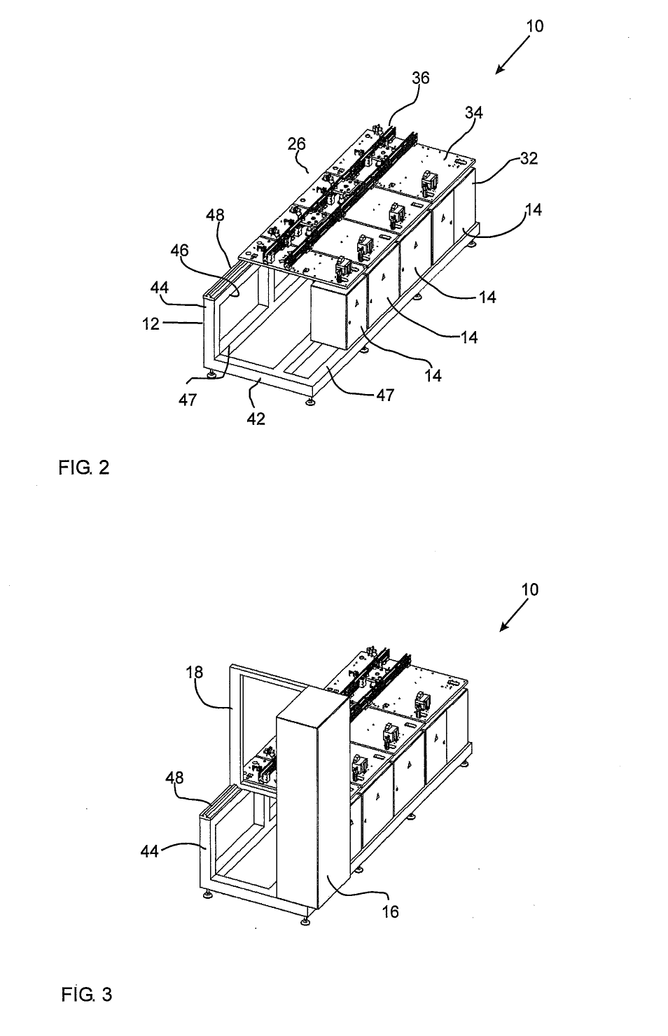

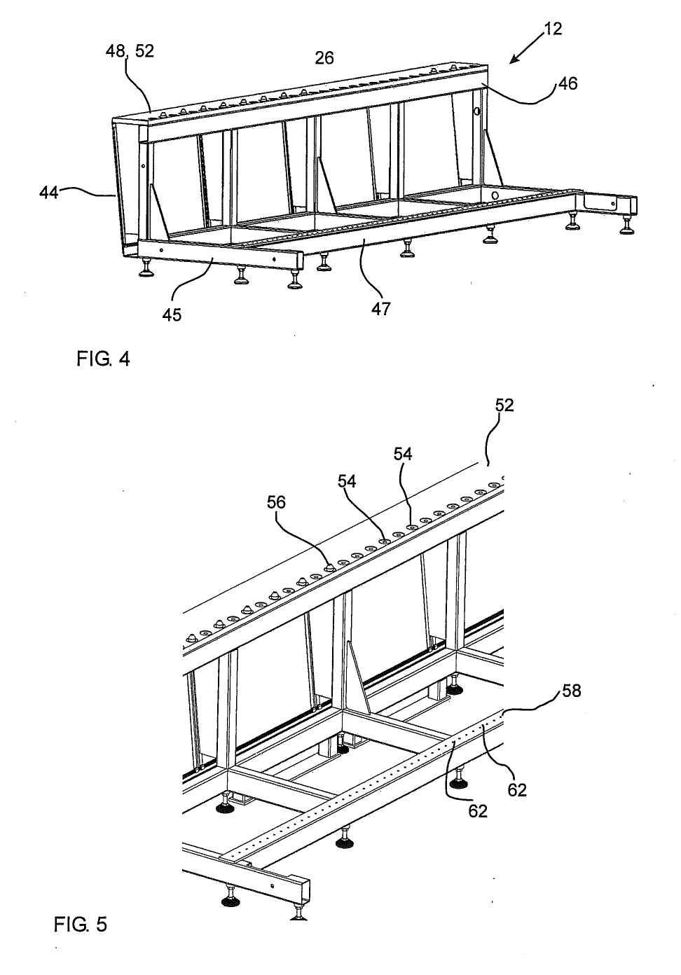

The construction of such a process bench 10 turns out to be very simple and is to be explained in detail below with reference to FIGS. 2 and 3.

A process bench 10 in a partly constructed state is shown in FIG. 2. In particular, the housing parts, such as side walls 18, rear wall 22 or door 20, and the switch cabinet 16 are absent.

The support device 12, which is composed of a rear wall element 44 and a base element 42, can clearly be seen. The rear wall element 44 is disposed perpendicularly to the base 42, thereby resulting in an L shape in cross section.

Both the base 42 and the rear wall element 44 are composed of individual longitudinal and cross members, wherein longitudinal members 47 running in parallel are connected to one another via transversely running cross members 45. The resulting spaces between longitudinal and cross members can remain free or be closed by plates, etc.

The rear wall element 44 has, as top termination, a longitudinal member 46 which extends over the entire length of the support device 12. Attached to this top longitudinal member 46 is a fastening rail 48, which, for example, may be T-shaped in cross section and is designed for interacting in a retaining and indexing manner with correspondingly complementary designed elements on the process modules 14.

It can clearly be seen in FIG. 2 that this fastening rail 48 extends over the entire length of the top longitudinal member 46 and consequently over the entire length of the support device 12.

The length of this fastening rail 48 defines an accommodating region, which is identified by the reference numeral 26 in FIG. 2. It is possible to insert process modules 14 into the support device 12 within this accommodating region 26.

This is done by the process module 14, which essentially comprises a process plate 34 and a switch cabinet 32, being pushed in from the front and then being set down.

In the process, a retaining element attached to the process plate 34 on the underside comes into contact with the fastening rail 48 in order thus to fix the position of the process module 14 in the transverse direction. Provided in the front region of the process modules 14 is a perpendicular member which extends downward from the underside of the process plate 34 and rests on one of the longitudinal members 47 of the base 42 and thus supports the process plate in a front region. These members are concealed in FIG. 2 by the respective switch cabinets 32 of the process modules 14.

With this type of fastening rail 48, it is possible to insert an individual process module 14 at any desired longitudinal position within the accommodating region 26. There are no fixed positions for the individual process modules. In addition, it would be theoretically conceivable for a process module to even be inserted at the transition from one support device 12 to a following support device.

It may be noted at this point that, for reasons of clarity, the actual construction on the process plate from the process point of view is blanked out, i.e. is not shown, in all the figures of the present invention.

The process bench 10 shown in FIG. 2 is shown in FIG. 3 and provided with further elements. These elements are a side wall 18 and the switch cabinet 16. It can clearly be seen from this figure that the side wall 18 likewise has a retaining element which is designed to be complementary to the fastening rail 48 and can thus be fastened to the rear wall element 44. As already stated in connection with the process modules 14, the side wall 18 can be attached at any desired point within the accommodating region 26. The side wall 18 is supported at the front via a perpendicular member which rests on a longitudinal member 47 of the base 42. This perpendicular member is concealed by the switch cabinet 16 in FIG. 3.

The switch cabinet 16 can likewise be arranged an any desired point within the accommodating region 26 of the support device 12, wherein it rests on longitudinal members 47 of the base 42.

Both FIGS. 2 and 3 also show parts of a conveying device, which is identified by the reference numeral 36 and extends over all the process modules 14, in the present case four process modules 14. Parts of the conveying device 36 are put onto the process plates of the individual process modules, wherein this conveying device 36 is likewise of modular construction and can be manipulated as an independent unit. It is likewise conceivable for each process module to have a separate conveying device. For reasons of clarity, however, no drive for belts of the conveying device 36 is shown in the figures. However, the drive could be accommodated together with the corresponding control in a functional module, which can be inserted like a process module 14 into the process bench 10.

The other elements shown in FIG. 1, such as side wall 18 (together with door 20 and rear wall 22), can likewise be inserted as individual elements into the support device 12.

It can be seen from FIGS. 1 to 3 that a process bench 10 can be constructed very simply, since all the elements can be inserted into the process bench in a modular manner. Not only the process modules 14 of modular construction but also all the other parts, in particular switch cabinets, housing parts, etc., can be inserted as “functional modules” into the support device 12.

On the whole, fixed base modules for accommodating process modules are dispensed with. Consequently there is no longer a conventional processing station which consists of a base module of fixed length having a fixedly attached switch cabinet and housing parts. Freed from the rigid structure of conventional processing stations, process benches can now be composed of any desired process and functional modules, wherein their positioning in the longitudinal direction is freely or essentially freely selectable.

A process bench 10 in different states of construction is likewise shown in FIGS. 4 to 7. The process bench 10 differs only marginally from the process bench 10 shown in FIGS. 1 to 3, and therefore a description of the parts identified by the same reference numerals can be dispensed with.

Here, too, the support device 12 is composed of longitudinal and cross members, thereby resulting in an L-shaped cross section.

A fastening rail 48 which is designed as a hole matrix plate 52 in the present exemplary embodiment is put on the top longitudinal member 46 of the support device 12. That is to say that a multiplicity of evenly spaced-apart holes 54 are incorporated in the hole matrix plate 52, said holes 54 running in the longitudinal direction, that is to say parallel to the top longitudinal member 46. These holes 54 can clearly be seen in FIG. 5. The distance between adjacent holes 54, in other words the size of the hole matrix, is selected as a function of the matrix size of the process modules. It is preferably selected in such a way that the process module matrix is a multiple of the hole matrix. In previous processing systems, a value of 400 mm has proved to be advantageous as process module matrix, that is to say the smallest nominal width of a process module (=physical overall width plus maneuvering gap size on the left and right, e.g. of 10 mm, per process module for the easy placing or release of a process module in or from a fully equipped process bench). With such a process module matrix, an advantageous value for the hole matrix size would be around 100 mm distance between adjacent holes 54. Other hole matrix sizes are of course likewise conceivable, as long as they are smaller than or are an integral divisor of the process module matrix.

It is of course also possible by means of the present invention to use finer process module matrices, e.g. 100 mm, and thereby configure process benches, processing systems and process modules/functional modules even more in keeping with the requirements.

It can be seen from FIGS. 4 and 5 that pins 56 can be inserted into the holes 54, said pins also having a fastening function in addition to the indexing.

As already mentioned in connection with the process bench 10 of FIGS. 1 to 3, the fastening rail 48 serves for the indexing and fastening of the inserted process modules and functional modules. On account of the use of a hole matrix and indexing pins 56 inserted therein, the process modules 14 and functional modules in this embodiment can no longer be inserted at any desired point within the accommodating region 26 of the support device 12 but rather only at positions predetermined by the hole matrix size. However, since a multiplicity of holes 54 are provided within a process module width, a process module or a functional module can be inserted at a very large number of positions. There is therefore no longer any restriction to, for example, four possible positions within a processing station, as is the case in the TEAMOS system mentioned in the introductory part of the description.

On the underside of the process plate 32, the process modules 14 have an element complementary to the indexing pins 56 and therefore have an opening in the form of a drill bush in which the indexing pins engage. For the final fastening of the process module on the support device 12, screws are inserted through these drill bushes and are screwed to the hole matrix plate 52.

The functional modules have identical or similar means in order to be able to fasten them to the support device.

In order to also fix each module 14 in the front region, a hole matrix plate 58 which has holes 62, in particular tapped holes, is put on a longitudinal member 47 of the base 42. The support, resting on this longitudinal member, of the process module can then likewise be fastened via screws.

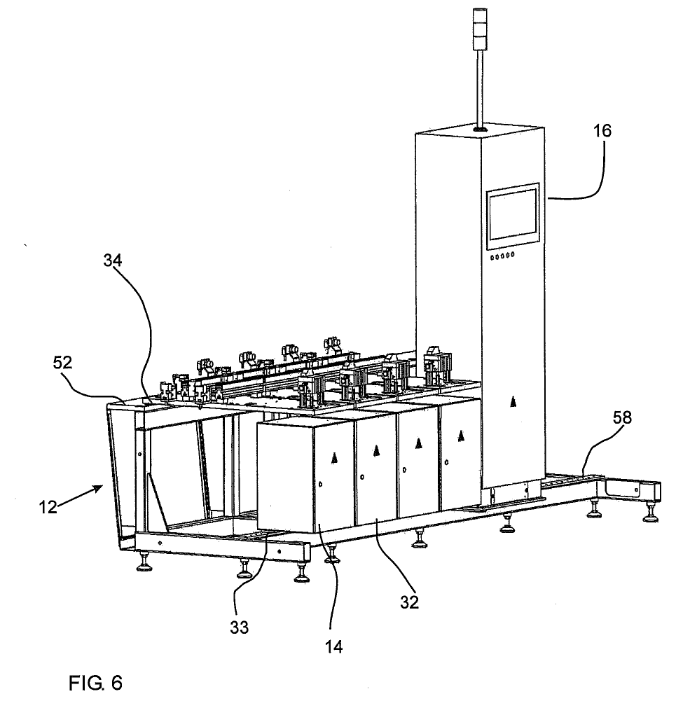

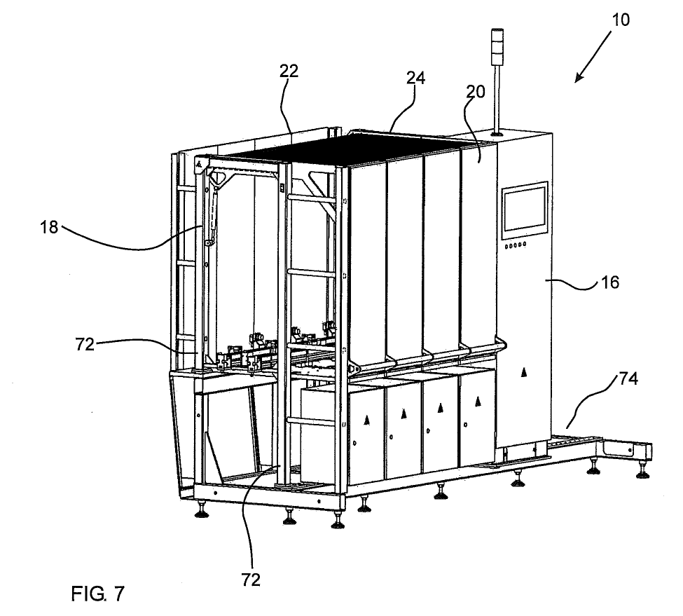

A part of a process bench 10 having such a support device 12 is constructed in FIGS. 6 and 7. A plurality of process modules 14, which rest with their process plate 34 on the hole matrix plate 52, can clearly be seen. A perpendicular member 33 can be at least partly seen in the front region, said member 33 resting on the hole matrix plate 58 and supporting the process plate. The switch cabinet 32 is then fastened to this member.

In addition, the process bench 10 has a switch cabinet 16 with operating panel, and this switch gear cabinet 16 forms a functional module and is attached to the support device 12 within the accommodating region. This switch cabinet 16 rests on longitudinal members 47 of the base 42 and is fixed at least to the hole matrix plate 58.

Finally, together with the side wall 18, the individual housing parts, such as rear wall 22, doors 20 or top 24, can also be put into the accommodating region of the support device, the housing parts likewise forming a functional module. The side wall 18 consists, for example, of members 72 which are supported on the bottom hole matrix plate 58 or the top hole matrix plate 52.

It can also be clearly seen in FIGS. 6 and 7 that the support device 12 has a free place within the accommodating region 26, this free place being identified in FIG. 7 by the reference numeral 74. This free place could be used for accommodating a further process module or functional module. On account of the modular type of construction, the switch cabinet 16 could in this case be shifted to the right in a very simple manner, such that the new process module can be installed directly following an existing process module. Such a flexible solution was not possible with the previous systems. This was in particular due to the fact that central switch cabinets, housing parts, etc., were fixed components of the base module and consequently could not readily be altered.

Finally, it would also be possible, for example, to extend the process bench 10, shown incomplete in FIG. 7, by a further support device 12, but without having to accept a further switch cabinet 16 for the central supply and control of the process modules.

It is therefore found on the whole that the process bench 10 according to the invention can be constructed and extended in a markedly more flexible manner due to the modular configuration of even those subassemblies which are not assigned to the process module. At this point, in particular the modularization of the base module should be mentioned, which can now be composed in a very variable manner from a support device and individual, self-contained, independent functional modules, wherein the functional modules can be inserted at any or virtually any desired point within the accommodating region of the support device. In addition, this increase in the flexibility has cost advantages, since the standardization of subassemblies can be further advanced and process benches in keeping with the requirements and equipped with process modules can be realized. Functional modules are only placed where they are needed.

What is claimed is:

1. A processing apparatus for processing, assembling or testing a workpiece transported on a work carrier, having a base module, which comprises a support device with an accommodating region, and at least one process module which can be inserted into the base module at a point within the accommodating region, wherein the support device is designed to accommodate process modules and/or functional modules at any desired point or at a multiplicity of predetermined points within the accommodating region.

2. The processing apparatus as claimed in claim 1, wherein the number of predetermined points is greater than the maximum number of process modules that can be inserted.

3. The processing apparatus as claimed in claim 1, wherein the support device is formed from at least one support element with a rear support and a bottom bearing surface.

4. The processing apparatus as claimed in claim 3, wherein the support device provides an accommodating region which extends over its entire length.

5. The processing apparatus as claimed in claim 1, wherein parts for constructing a housing are designed as functional modules which can be inserted into the accommodating region.

6. The processing apparatus as claimed in claim 1, wherein a central control device assigned to the processing apparatus or to a specific number of process modules is designed as a functional module which can be inserted into the accommodating region.

7. The processing apparatus as claimed in claim 1, wherein the conveying device provided for transporting the work carriers is designed as a functional module which can be inserted into the accommodating region.

8. The processing apparatus as claimed in claim 3, wherein the support device has a length selected independently of the width of the process modules that can be inserted.

9. The processing apparatus as claimed in claim 3, wherein the support device is composed of at least two support elements.

10. The processing apparatus as claimed in claim 3, wherein the support has a fastening rail which extends over the entire length of the accommodating region and which interacts in a retaining and indexing manner with a retaining element attached to a process plate of the process module or with a retaining element attached to a functional module.

11. The processing apparatus as claimed in claim 10, wherein the fastening rail is designed so as to be essentially T-shaped in cross section or so as to be provided with a T-shaped slot in cross section and enables a process module or functional module to be placed in any desired manner.

12. The processing apparatus as claimed in claim 10, wherein the fastening rail has a hole matrix for accommodating indexing and fastening pins.

13. The processing apparatus as claimed in claim 12, wherein the hole matrix size is an integral divisor of the process module matrix width.

14. The processing apparatus as claimed in claim 3, wherein the bearing surface of the support device has at least one hole matrix rail extending over the length of the accommodating region, the hole matrix corresponding to that of the fastening rail.

15. A process module for a processing apparatus for processing, assembling or testing a workpiece transported on a work carrier, having a base module, which comprises a support device with an accommodating region, and at least one process module which can be inserted into the base module at a point within the accommodating region, wherein the support device is designed to accommodate process modules and/or functional modules at any desired point or at a multiplicity of predetermined points within the accommodating region, said process module having a process plate and a switch cabinet, wherein at least one retaining element is provided on the process plate, said retaining element being adapted to the fastening rail of the support of the support device in order to interact with said fastening rail in a retaining and indexing manner.

16. The process module as claimed in claim 15, wherein the retaining element is designed as a drill bush in the process plate, in which drill bush an indexing pin attached to the fastening rail can engage.

17. The process module as claimed in claim 15, wherein fastening elements which interact with the bearing surface of the support device are provided on the underside of the process plate of the process module.
